(19) United States
(12) Patent Application Publication
(10) Pub. No.: US 2024/0406794 A1
(43) Pub. Date: Dec. 5, 2024

(54) METHOD AND APPARATUS FOR REPORTING PHYSICAL LAYER INFORMATION

(71) Applicant: Huawei Technologies Co., Ltd., Shenzhen (CN)

(72) Inventors: Hao Tang, Ottawa (CA); Jianglei Ma, Ottawa (CA)

(21) Appl. No.: 18/807,557

(22) Filed: Aug. 16, 2024

Related U.S. Application Data
(63) Continuation of application No. PCT/CN2022/076632, filed on Feb. 17, 2022.

(51) Int. Cl. H04W 28/02; H04L 5/00

(52) U.S. Cl. CPC H04W 28/0278; H04L 5/0053

(57) ABSTRACT

Physical layer information reporting related to uplink physical layer information that is to be transmitted by a user equipment (UE) to a network device in a wireless communication network may involve communicating signaling between the UE and the network device. The signaling may be communicated by the UE transmitting the signaling to the network device and/or the network device receiving the signaling from the UE. The signaling is indicative of an amount of the uplink physical layer information that is to be transmitted. The physical layer information may include control information, data information, or both control information and data information in the physical layer. The amount may be reported explicitly, in a medium access control (MAC) control element (MAC-CE) with or without an indication of information type for example, or implicitly based on a communication resource mapping for example.

### CROSS REFERENCE

The present application is a continuation of International Application No. PCT/CN2022/076632, filed on Feb. 17, 2022, the disclosure of which is hereby incorporated by reference in its entirety.

### TECHNICAL FIELD

The present disclosure relates generally to wireless communications and, in particular embodiments, to reporting amounts of uplink physical layer information that is to be transmitted from a user equipment (UE) to a network device in a wireless communication network.

### BACKGROUND

In long term evolution (LTE) and new radio (NR), a buffer status reporting procedure is used to provide a serving base station with information about uplink (UL) data volume in a medium access control (MAC) entity. A buffer status report (BSR) is a kind of MAC control element (MAC-CE) from UE to network, carrying information on how much data is in a UE buffer to be sent out.

Current buffer status reporting procedure is for data transmission to high layers above layer 1 (L1) and reported data volume to transmit is based on how much data is in radio link control (RLC) and packet data convergence protocol (PDCP) layers.

Reporting of buffer size or amount of physical layer information to be transmitted remains an issue.

### SUMMARY

In sixth generation (6G) wireless communication networks, it is expected that more UL layer 1 (L1) data will be involved in real-time intelligent operation in physical layer (PHY), and payload size of UL L1 data may be flexible and determined at least in part by UEs.

According to an aspect of the present disclosure, a method involves transmitting, by a UE to a network device in a wireless communication network, signaling indicative of an amount of uplink physical layer information to be transmitted from the UE to the network device. The physical layer information includes control information, data information, or both control information and data information in the physical layer.

A UE according to another aspect of the present disclosure includes a processor and a non-transitory computer readable storage medium that is coupled to the processor. The non-transitory computer readable storage medium stores programming for execution by the processor. The programming includes instructions to, or to cause the processor to, transmit signaling to a network device in a wireless communication network. The signaling is indicative of an amount of uplink physical layer information to be transmitted from the UE to the network device. The physical layer information includes control information, data information, or both control information and data information in the physical layer.

A computer program product includes a non-transitory computer readable medium storing programming, and the programming includes instructions to, or to cause a processor to, transmit signaling from a UE to a network device in a wireless communication network. The signaling is indicative of an amount of uplink physical layer information to be transmitted from the UE to the network device, and the physical layer information includes control information, data information, or both control information and data information in the physical layer.

A method according to yet another aspect of the present disclosure involves receiving, by a network device from a UE in a wireless communication network, signaling indicative of an amount of uplink physical layer information to be transmitted from the UE to the network device. As in other embodiments, the physical layer information includes control information, data information, or both control information and data information in the physical layer.

In another embodiment in which a network device includes a processor and a non-transitory computer readable storage medium that is coupled to the processor and stores programming for execution by the processor, the programming may include instructions to, or to cause a processor to, receiving signaling from a UE in a wireless communication network. The signaling is indicative of an amount of uplink physical layer information to be transmitted from the UE to the network device, and the physical layer information includes control information, data information, or both control information and data information in the physical layer.

Programming stored in a non-transitory computer readable medium of a computer program product may include instructions to, or to cause a processor to, receive by a network device from a UE in a wireless communication network, signaling indicative of an amount of uplink physical layer information to be transmitted from the UE to the network device. The physical layer information includes control information, data information, or both control information and data information in the physical layer.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example of a logical channel identifier (LCID) values for UL-SCH in a MAC subheader according to an embodiment.

FIG. 6 is a block diagram illustrating an example BSR according to an embodiment.

FIG. 7 is a block diagram illustrating an example of LCID values for uplink shared channel (UL-SCH) in a MAC subheader according to another embodiment.

FIG. 8 is a block diagram illustrating an example BSR with reported information types according to another embodiment.

FIG. 9 is a block diagram illustrating an example mapping between SR resources and respective physical layer information buffer sizes.

FIG. 10 is a block diagram illustrating an example mapping between SR resources and physical layer information types.

FIG. 11 is a signal flow diagram illustrating interactions between a UE and a network device in some embodiments.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

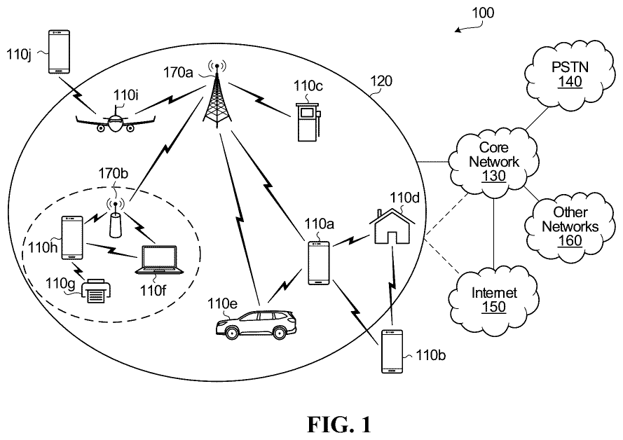

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

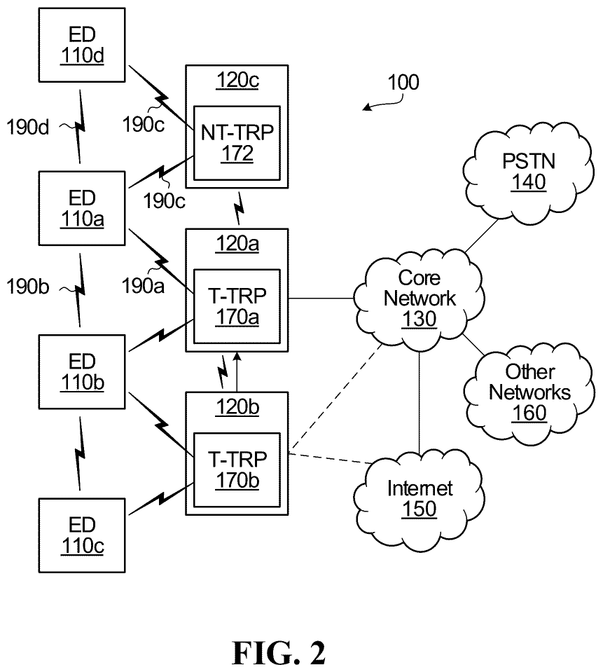

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172. The air interfaces 190a and 190b may use similar communication technology,

such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

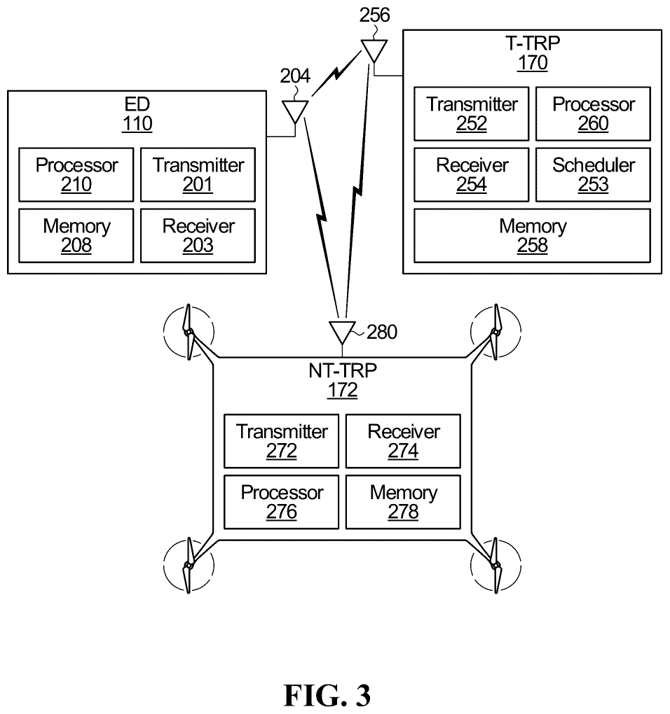

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

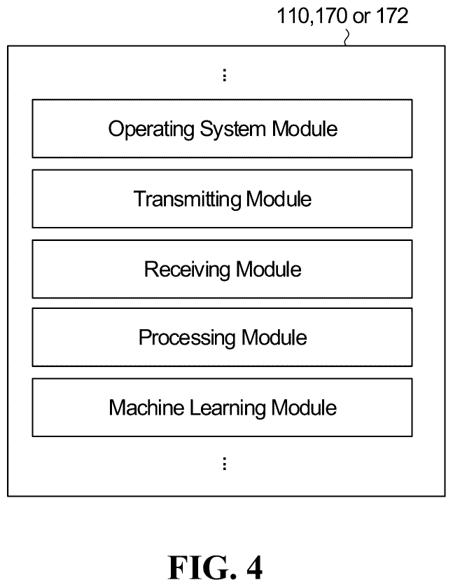

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Embodiments disclosed herein encompass UE reporting related to physical layer information. Such reporting involves a UE reporting, to a network device such as a base station, the amount of UL physical layer information that is to be transmitted from the UE to the network device. Physical layer information may also or instead be referred to as physical layer (PHY) data, assistant PHY information or data, or L1 information or data, and may be or include either or both of control signaling or information and data traffic or information. Another way to describe or characterize physical layer information is that it has no associated logical channel.

In 6G, it is expected that features such as real-time intelligent operation in PHY may involve more UL physical layer information being transmitted from UEs to network devices. For example, physical layer information may include information that is related to artificial intelligence (AI) model performance and is transmitted during AI implementation. AI or machine learning (AI/ML) accuracy, AI/ML loss value such as mean square error and/or mean absolute error, gradients, block error rate (BLER), bit error rate (BER), throughput, and latency are examples of physical layer information, any one or more of which may be transmitted during AI implementation.

Physical layer information may also or instead include assistant information for AI training or re-training/update, such as any one or more of: correlation between a base station model or other network-side model and a UE local model, and gradients.

Sensing data is another example of physical layer information, and may include data related to doppler or rate of fading, such as any one or more of: level cross level cross rate (LCR), average fading duration (AFD), delay of multipath, average delay, and delay spread.

Physical layer information and reporting may be dynamic in that a UE may have different physical layer information to report in different time slots, for example, and there may be no need to report on physical layer information repeatedly if there has been no change. A UE may self-determine UL physical layer information reporting to a network device. It may therefore be desirable to provide for physical layer information reporting that enables a network device such as a base station to be informed that UL data to be transmitted by a UE is UL physical layer information, and the amount of physical layer information that is to be transmitted.

According to an embodiment, a MAC-CE includes an L1 BSR that indicates that the BSR is for UL physical layer information, and the buffer size. In the UL physical layer information that is subsequently transmitted by a UE, the UE may report whether each of multiple types of physical layer information is present, and the value of that physical layer information if it is present.

Another embodiment also involves a MAC-CE that includes an L1 BSR and reported physical layer information types. Such a MAC-CE indicates the buffer size of physical layer information, and physical layer information types reported by the UE.

In a further embodiment, there is no explicit BSR, and a network device such as a base station configures a mapping between a scheduling request (SR) resource and physical layer information buffer size. An SR may thereby be dedicated to UL physical layer information, and based on the SR resource that is used by a UE, a network device is able to determine the physical layer information buffer size.

These and other embodiments disclosed herein may be generalized, in method form for example, as involving transmitting, by a UE to a network device in a wireless communication network, signaling that is indicative of an amount of uplink physical layer information that is to be transmitted from the UE to the network device. The physical layer information may be or include control information, data information, or both control information and data information in the physical layer. Further, the signaling comprises a medium access control-control element (MAC-CE) or uplink physical signaling in physical uplink control channel (PUCCH) or physical uplink shared channel (PUSCH).

In some embodiments, either or both of the type and the amount of physical layer information that is available at the UE for transmission may be determined by the UE. Other embodiments may involve physical layer information type(s) and/or amount(s) being jointly determined by a network device and a UE. For example, a network device such as a base station may configure available types of physical layer information, and a UE may select one or multiple types to report to the network device.

Signaling that is indicative of an amount of uplink physical layer information to be transmitted from a UE to a network device may be or include a BSR indicating the amount of uplink physical layer information. The BSR may be, or be part of, a MAC-CE for example. An identifier such as a logical channel identifier (LCID) value in a MAC subheader may be included in the signaling to identify a type of the MAC-CE as a BSR MAC-CE for the uplink physical layer information or indicate that the BSR is for UL physical layer information.

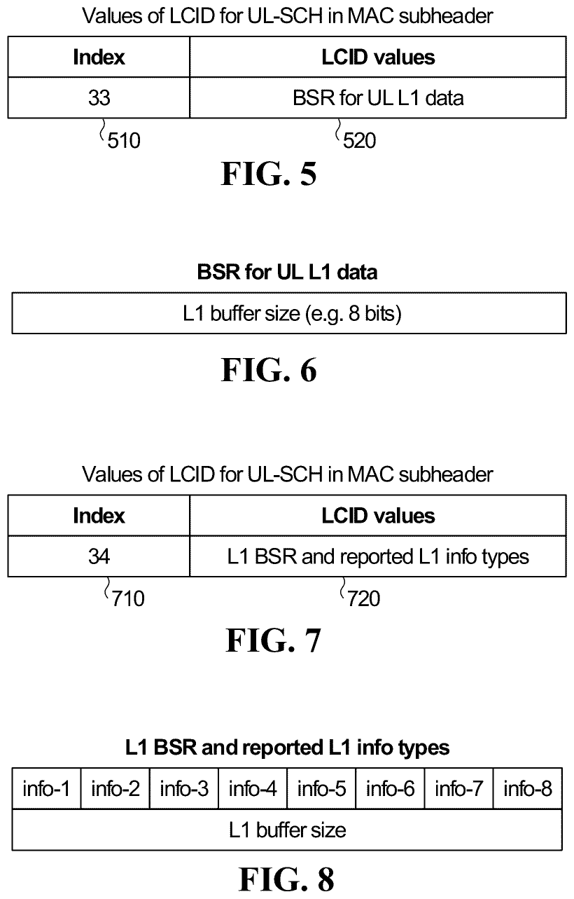

FIG. 5 is a block diagram illustrating an example of LCID values for UL-SCH in a MAC subheader according to an embodiment. An LCID index 510, which is 33 in the example shown, indicates an LCID value 520 of “BSR for UL L1 data” in the example shown. The index 33 is provided as an illustrative example, because it is one of a number of reserved indices in the above-referenced technical specification 3GPP TS 38.321 V15.7.0. Embodiments are not in any way limited to this index, or the example LCID value, shown in FIG. 5.

In terms of data structure, a MAC-CE of “BSR for UL L1 data” includes L1 buffer size only, and no LCG ID because the buffer size is for physical layer information. Physical layer information is not for logical channels and has no associated logical channel.

FIG. 6 is a block diagram illustrating an example BSR according to an embodiment. The number of bits of L1 buffer size indicated in a BSR for physical layer information may be pre-configured or pre-defined, and is 8 bits in the example L1 BSR in the example shown.

A MAC-CE for physical layer information reporting, such as a “BSR for UL L1 data”, may have a higher priority than other MAC-CEs for MAC multiplexing in some embodiments. In MAC layer, to support priority handing, multiple logical channels and MAC-CEs can be multiplexed into one transport channel, within a MAC protocol data unit (PDU), and a “BSR for UL L1 data” MAC-CE or other MAC-CE for physical layer information reporting may be the first MAC-CE(s) to be included into a MAC PDU by a UE.

By receiving a MAC-CE that is used for physical layer information reporting, a network device such as a base station knows that the UE will report physical layer information. The network device may allocate UL communication resources to the UE to transmit the physical layer information. The resource allocation, such as the number of allocated resources, is based on the reported amount of physical layer information, such as physical layer information buffer size. The UL resources may include one or more of time resources, frequency resources, and spatial resources of one or more UL data channels such as physical uplink shared channel (PUSCH) and/or one or more control channels such as physical uplink control channel (PUCCH).

The data format of UL physical layer information is configured by the network device in some embodiments. For example, a base station may configure one or more fields for physical layer information. For a type of physical layer information, to be carried in one field for example, a UE may transmit to the network device an indication as to whether that type of physical layer information is present in the physical layer information to be transmitted, and if present, a value of that type of physical layer information.

As an example, physical layer information may include any one or more of the following types in some embodiments, with a 1-bit indication of presence for each type and a value of the physical layer information of each type if present:
AI/ML model accuracy:
   1-bit presence: 1 indicates present, 0 indicates absent
   Value of AI/ML accuracy: if present N1 bits; otherwise 0 bits
AI/ML loss: 1 indicates present, 0 indicates absent
   1-bit presence: 1 indicates present, 0 indicates absent.
   Value of AI/ML loss: if present N2 bits; otherwise 0 bits
Gradients.
   1-bit presence: 1 indicates present, 0 indicates absent
   Value of gradients: if present N3 bits; otherwise 0 bits
Doppler.
   1-bit presence: 1 indicates present, 0 indicates absent.
   Value of Doppler: if present N4 bits; otherwise 0 bits
Correlation between BS and UE models
   1-bit presence: 1 indicates present, 0 indicates absent.
   Value of correlation: if present N5 bits; otherwise 0 bits.

These are examples only, and different indicators of presence and/or value may be used in other embodiments. For example, different types may have different presence indications, and/or the same or different lengths or formats for values.

A new MAC-CE for physical layer information reporting, such as “BSR for UL L1 data” described herein as an example, may support buffer size reporting for physical layer information, to enable real-time UL reports. Such a MAC-CE enables a network device to allocate accurate resources for UL physical layer information transmission. Otherwise, the network device may blindly allocate resources, and a UE may need multiple transmissions if the resources are not sufficient.

Another form of MAC-CE that may be used in physical layer information reporting includes an L1 BSR and reported physical layer information types. Signaling that is indicative of an amount of uplink physical layer information to be transmitted from a UE to a network device may be or include a BSR indicating the amount of uplink physical layer information as described at least above. Such signaling may be further indicative of which of a plurality of different types of uplink physical layer information are included in the amount of uplink physical layer information that is reported to the network device.

As in other embodiments disclosed herein, an identifier such as an LCID value in a MAC subheader may be included in the signaling to identify a type of the MAC-CE as a BSR MAC-CE for the uplink physical layer information or indicate that the BSR is for UL physical layer information.

FIG. 7 is a block diagram illustrating an example of LCID values for UL-SCH in a MAC subheader according to another embodiment. An LCID index 710, which is 34 in the example shown, indicates an LCID value 720 of “L1 BSR and reported L1 info types” in the example shown. The index 34 is provided as an illustrative example, because it is one of a number of reserved indices in the above-referenced technical specification 3GPP TS 38.321V15.7.0. The LCID value 720 of “L1 BSR and reported L1 info types” not only indicates that the BSR is for physical layer (L1) information, but also indicates the L1 information that UE will report. Embodiments are not in any way limited to this index, or the example LCID value, shown in FIG. 7.

In terms of data structure, a MAC-CE of “L1 BSR and reported L1 info types” includes L1 buffer size and physical layer information types only, but no LCG ID because the buffer size is for physical layer information. Physical layer information is not for logical channels and has no associated logical channel, as also noted elsewhere herein. FIG. 8 is a block diagram illustrating an example BSR with reported information types according to another embodiment, and in particular a MAC-CE of “L1 BSR and reported L1 info types”.

In FIG. 8, Info-i represents a field that indicates the presence of a buffer size field for physical layer information i. Information i refers to one type of physical layer information, and may be pre-defined or pre-configured, such as AI/ML loss, gradient, etc. In some embodiments, an Info-i field set to 1 indicates that the buffer size field for information i is reported, and the Info-i field set to 0 indicates that the buffer size field for information i is not reported. This is one example of a bitmap to indicate whether each of a plurality of different types of uplink physical layer information is included in the amount of uplink physical layer information that is reported from a UE to a network device. Other presence/absence indications may be used in other embodiments.

The L1 buffer size field in FIG. 8 provides an example of how the total amount of physical layer information that is to be transmitted may be indicted. This field indicates total size of all of the physical layer information types, Info-i.

The total amount of physical layer information that is to be transmitted may be indicated in any of various ways. For example, the L1 buffer size field shown in FIG. 6 may indicate a buffer size as a number of bytes to report the amount of physical layer information that is to be transmitted. Another possible option is an index or other bit value in the L1 buffer size field, which is mapped to buffer size in bytes for example. In this case the amount of uplink physical layer information that is to be transmitted is indicated by the index, and the mapping between the index and buffer size is used to determine the buffer size. Such a mapping may be specific to uplink physical layer information, or a mapping that is also used for other purposes, such as for buffer size reporting for logical channels, may be used for reporting amounts of uplink physical layer information to be transmitted.

Features disclosed herein in respect of a BSR for physical layer information may be provided BSRs that do or do not include reported information types. For example, a MAC-CE that includes an “L1 BSR and reported L1 info types” may have a higher priority than other MAC-CEs for MAC multiplexing, as described at least above for “BSR for UL L1 data” MAC-CEs.

By receiving a MAC-CE of “L1 BSR and reported L1 info types”, a network device such as a base station knows that the UE will report physical layer information and the type(s) of physical layer information that will be transmitted by the UE to the network device. The network device may allocate UL communication resources to the UE to transmit the physical layer information, and resource allocations are provided elsewhere herein.

The data format of UL physical layer information is configured by the network device in some embodiments. For example, a base station may configure one or more fields for physical layer information. In a MAC-CE of “L1 BSR and reported L1 info types”, a UE indicates to the network device whether each type of physical layer information is to be transmitted and will be present in a subsequent transmission of physical layer information. If present, the UE transmits the value of a type of physical layer information. Thus, a method may involve transmitting, by the UE to the network device, a value of each of multiple different types of physical layer information that is included in the amount of uplink physical layer information that was reported to the network device, in a MAC-CE of “L1 BSR and reported L1 info types” for example.

The values of the present types of physical layer information included in the amount of uplink physical layer information reported to the network device may be concatenated in a transmission to the network device. The values may be concatenated in order of physical layer information type identifiers that identify the different types of physical layer information, or in another order. In general, a UE may concatenate present information types according to any of various pre-defined rules, from lowest to highest Info-i or other identifier or index for example.

Considering an “L1 BSR and reported L1 info types” MAC-CE again as an example, a UE may inform a network device that it will report physical layer information types Info-1 and Info-5, with Info-1 being AI/ML model accuracy and Info-5 being Correlation between base station and UE models. In this example, physical layer information then the UL report for L1 data includes:
AI/ML model accuracy:
   Value of AI/ML accuracy
Correlation between BS and UE models.
   Value of correlation.

This is one example only, and different types of physical layer information may also or instead be reported and/or transmitted from a UE to a network device. Other examples of physical layer information are provided elsewhere herein.

Physical layer information embodiments that involve “L1 BSR and reported L1 info types” MAC-CEs, like those that involve “BSR for UL L1 data” MAC-CEs, may support buffer size reporting for physical layer information, to enable real-time UL reports. As discussed at least above for L1 BSR MAC-CEs, an “L1 BSR and reported L1 info types” MAC-CE enables a network device to allocate accurate resources for UL physical layer information transmission, to avoid the network device blindly allocate resources that may be insufficient.

MAC-CE embodiments, including the “BSR for UL L1 data” and “L1 BSR and reported L1 info types” examples, illustrate different options for reporting or indicating types of uplink physical layer information from a UE to a network device. An “L1 BSR and reported L1 info types” MAC-CE provides an example of signaling that includes indications of physical layer information types and an indication of an amount of physical layer information to be transmitted, whereas a “BSR for UL L1 data” MAC-CE provides an example of signaling that includes only an indication of an amount of physical layer information to be transmitted. According to another embodiment, there is no explicit BSR or other form of explicit indication of an amount of physical layer information that is to be transmitted, and mapping between a scheduling request (SR) resource and physical layer information buffer size provides a form of implicit indication of the amount of physical layer information that is to be transmitted by a UE.

For UL physical layer information scheduling, a network device such as a BS may configure dedicated SR resources to a UE. When the network device receives an SR on a dedicated SR resource, the network device knows that the SR is an SR for scheduling UL physical layer information. In addition, the network device may configure a mapping between an SR resource and a physical layer information amount or buffer size, such that a dedicated SR resource is linked to a specific physical layer information amount or buffer size. Multiple dedicated SR resources may be mapped or linked to respective different physical layer information amounts or buffer sizes. Based on the SR resource used by a UE, a network device that received an SR from the UE knows the physical layer information amount or buffer size, and allocates UL resources accordingly. In this solution, no BSR MAC-CE is transmitted by the UE.

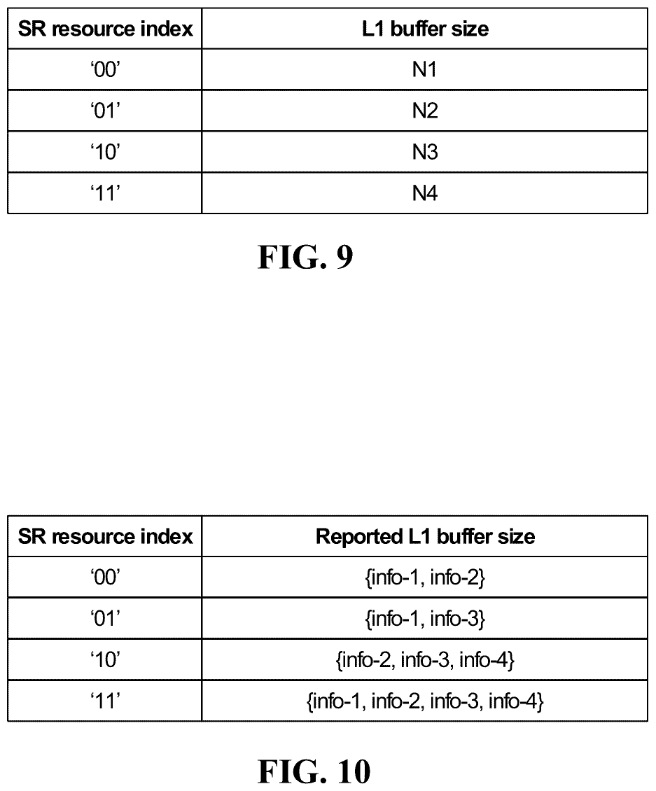

FIG. 9 is a block diagram illustrating an example mapping between SR resources and respective physical layer information buffer sizes. As shown, each of multiple SR resources (four in FIG. 9) is uniquely mapped to a corresponding, respective, different buffer size or amount of physical layer information. The mapping in FIG. 9 is for four resources and four buffer sizes or amounts, but other embodiments may map more or fewer resources and amounts. Also, each SR resource is mapped using an SR resource index in FIG. 9. Other embodiments may use other types of identifiers to map SR resources to amounts of physical layer information.

Such a mapping may be configured at a UE by a network device, and resource and physical layer information amount information for the mapping, such as SR resource indices and corresponding buffer sizes for the example in FIG. 9, may be stored in memory at the UE and the network device. Stored mapping information enables the UE to determine the SR resource to use for an SR based on the amount of physical layer information that is to be transmitted, and enables the network device to determine how much physical layer information is to be transmitted by the UE based on the SR resource on which it received an SR from the UE.

Regarding transmission of uplink physical layer information, the UE may transmit an indication as to whether a type of physical layer information is present in the physical layer information, and a value of the type of physical layer information if present. Transmission of uplink physical layer information types and values are described by way of example at least above, in the context of L1 BSR embodiments. Although resource mapping embodiments do not involve a BSR, resource mapping embodiments may use an approach to transmitting physical layer information that is the same as or similar to an approach disclosed for L1 BSR embodiments.

Another embodiment involves a network device configuring a mapping between one or more dedicated SR resources and one or more types of physical layer information. One SR resource may be mapped to one or multiple physical layer information types. Based on the SR resource on which an SR is received, a network device determines the physical layer information types that a UE is to transmit. The network device may also calculate or otherwise determine an amount of physical layer information types that the UE is to transmit, based on the SR and/or the type(s) of physical layer information.

FIG. 10 is a block diagram illustrating an example mapping between SR resources and physical layer information types. As shown, each of multiple SR resources (four in FIG. 10) is mapped to a corresponding, respective, different set of physical layer information types. Although each set includes multiple information types in FIG. 10, in general each SR resource may be uniquely mapped to a respective set of one or more physical layer information types. The mapping in FIG. 10 is for four resources and four sets of information types, but other embodiments may map more or fewer resources to more or fewer sets of information types. Each SR resource is mapped using an SR resource index in FIG. 10. Other embodiments may use other types of identifiers to map SR resources to physical layer information types.

As described at least above for SR resource/buffer size mapping, a mapping between SR resources and physical layer information types may be configured at a UE by a network device. Resource information and physical layer information types for the mapping, such as SR resource indices and information type identifiers for the example in FIG. 10, may be stored in memory at the UE and the network device. Stored mapping information enables the UE to determine the SR resource to use based on the type(s) of physical layer information to be transmitted by the UE, and enables the network device to determine the type(s) of physical layer information to be transmitted by the UE based on the SR resource on which it received an SR from the UE.

Transmission of uplink physical layer information may be the same as or similar to an approach that is disclosed at least above in the context of reporting information types in a MAC-CE, such as “L1 BSR and reported L1 info types”. For example, the UE may concatenate values for different information types. Concatenation may be according to any of various pre-defined rules, such as from lowest to highest Info-i or other identifier or index.

In SR resource mapping embodiments, no MAC-CE is transmitted by the UE. SR resource mapping embodiments involve a UE transmitting signaling that indicates an amount of physical layer information on a communication resource that is configured for uplink physical layer information reporting. The communication resource may be or include an SR communication resource that is dedicated to uplink physical layer information. The communication resource may be linked, associated with, or otherwise mapped to the amount of uplink physical layer information that the UE has to transmit to the network device as shown by way of example in FIG. 9, or to a type of uplink physical layer information as shown by way of example in FIG. 10.

In another embodiment, one or more SR resources may be mapped to both amount of uplink physical layer information and type of uplink physical layer information. With reference to FIG. 9 and FIG. 10, for example, an SR resource index such as ‘00’ may be mapped to L1 buffer size N1 for types Info-1 and Info-2, a different SR resource may be mapped to L1 buffer size N2 for types Info-1 and Info-2, and so on, for different combinations of buffer sizes and sets of one or more information types.

SR resource mapping supports amount or buffer size reporting and information type reporting for physical layer information, enabling real-time UL reporting. Such reporting may enable a network device to allocate accurate resources for UL physical layer information transmission and avoid blindly allocating resources that may be insufficient.

Embodiments disclosed herein include embodiments that involve explicit indications of uplink physical layer information amounts, with or without explicit indications of uplink physical layer information type(s), in new types of MAC-CEs, for example. Other embodiments involve implicit indications of uplink physical layer information amounts, type(s), or both, based on SR resource mapping, for example. Values of uplink physical layer information may be transmitted on their own, or with indications of presence or absence of information types.

Transmission of uplink physical layer information may involve transmitting the uplink physical layer information, by the UE to the network device, on a communication resource that is allocated to the UE based on the amount of uplink physical layer information. In some embodiments, transmitting the uplink physical layer information involves transmitting the uplink physical layer information in a format that is configured by the network device for the uplink physical layer information. Concatenation of present information types is an example of one possible format, and others, which may but need not necessarily be configured by the network device, are possible.

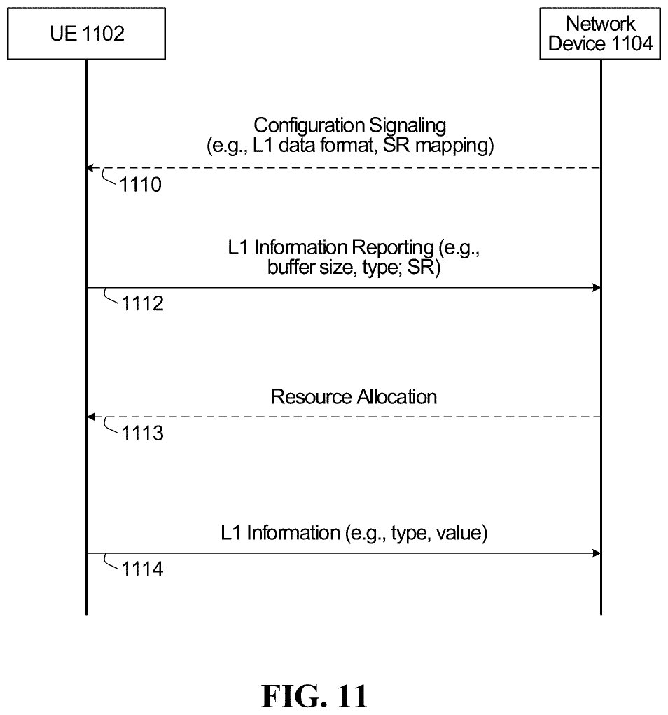

FIG. 11 is a signal flow diagram illustrating interactions between a UE and a network device in some embodiments.

Embodiments are described above primarily from the perspective of a UE. As illustrated by way of example in FIG. 11, embodiments may involve not only a UE 1102, but also or instead a network device 1104.

For example, various features related to transmitting signaling by a UE to a network device at 1110 are described herein, and from the perspective of a network device a method may also or instead involve receiving, by a network device 1104 from a UE 1102 in a wireless communication network, signaling that is indicative of an amount of uplink physical layer information to be transmitted from the UE to the network device.

Features disclosed elsewhere herein may be provided in network-side methods. As described at least above, for example, the physical layer information for which report signaling is received by the network device 1104 at 1110 may be or include control information, data information, or both control information and data information in the physical layer. The uplink physical layer information may be determined by the UE 1102 in some embodiments, and has no associated logical channel because it is physical layer information.

Network-side embodiments may involve signaling that is or includes a BSR indicating the amount of uplink physical layer information. A BSR may be or include a MAC-CE, with an identifier in a MAC subheader to identify a type of the MAC-CE as a BSR MAC-CE for the uplink physical layer information, for example.

The signaling received by the network device 1104 at 1110 may also be indicative of which of different types of uplink physical layer information are included in the amount of uplink physical layer information. The signaling may be or include a bitmap to indicate whether each of the different types of uplink physical layer information is included in the amount of uplink physical layer information, for example. Such a bitmap may be included in a MAC subheader in some embodiments.

A MAC-CE for uplink physical layer information, which may or may not include an indication of information type, may have a higher priority than another MAC-CE for MAC multiplexing, as also described elsewhere herein.

Uplink physical layer information may be transmitted by the UE and received by the network device 1104 on a communication resource that is allocated to the UE by the network device, or another network node, based on the amount of uplink physical layer information that is to be transmitted. Signaling indicative of resource allocation is illustrated in FIG. 11 by way of example at 1113. A method may involve the network device 1104 or another network node allocating a communication resource based on the amount of uplink physical layer information that is reported at 1112. The example shown in FIG. 11 involves, at 1113, the network device 1104 transmitting to the UE 1102 signaling that is indicative of the allocated communication resource, and the UE receiving from the network device the signaling that is indicative of the allocated communication resource.

Transmission of uplink physical information by the UE 1102, at 1114 in FIG. 11, has counterpart reception features at the network device 1104 in the example shown. In embodiments that do not involve reporting information types with buffer size or another indication of an amount of information to be transmitted, a method may involve receiving, by the network device 1104 from the UE 1102, an indication as to whether a type of physical layer information is present in the physical layer information, and a value of the type of physical layer information if present. Receiving by the network device 1104 at 1114 may involve receiving a value of each type of physical layer information, without also receiving an indication of type(s) with information value(s). This may be the case, for example, in embodiments that involve reporting information type(s) with information amount(s) at 1112. The values of multiple types of physical layer information received at 1114 may be concatenated, in order of physical layer information type identifiers that identify the types of physical layer information, for example.

Some embodiments do not involve reporting with an explicit indication of the amount of uplink physical layer information that is to be transmitted. A method may involve the network device 1104 receiving the signaling at 1110 on a communication resource that is configured, by the network device at 1110 or another network node, for uplink physical layer information reporting. As also described elsewhere herein, the communication resource may be or include an SR communication resource that is dedicated to uplink physical layer information. Such a communication resource may be mapped to the amount of uplink physical layer information, a type of uplink physical layer information, or both the amount of uplink physical layer information and a type of uplink physical layer information.

The uplink physical layer information may be received by the network node 1104 from the UE 1102 at 1114 in a format that is configured, by the network device at 1110 or another network node, for the uplink physical layer information.

Configuration signaling is illustrated at 1110, and may involve transmitting signaling by the network device 1104 and receiving signaling by the UE 1102. Signaling related to configuration may be indicative of, for example, one or more of the following: a communication resource that is configured for uplink physical layer information reporting; mapping of communication resources and amounts of uplink physical layer information, types of uplink physical layer information, or both amounts and types of uplink physical layer information; a communication resource that is allocated based on the amount of uplink physical layer information; and a format that is configured for the uplink physical layer information.

FIG. 11 is intended as an illustrative and non-limiting example of how UE features may have counterpart features at a network device, and how a UE and a network device may interact. Other features disclosed herein, even if not explicitly described with reference to FIG. 11, may be provided for a UE, for a network device, or both.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

From the perspective of a UE as an illustrative example, programming stored in or on a non-transitory computer readable storage medium may include instructions to, or to cause a processor to, transmit to a network device in a wireless communication network, signaling indicative of an amount of uplink physical layer information to be transmitted from the UE to the network device. The physical layer information may be or include control information, data information, or both control information and data information in the physical layer.

Embodiments related to UEs or non-transitory computer readable storage media for UE operations may include any one or more of the following features, for example, which are also discussed elsewhere herein:
the uplink physical layer information is determined by the UE;
the uplink physical layer information has no associated logical channel;
the signaling is or includes a BSR indicating the amount of uplink physical layer information;
the BSR is, or is part of, MAC-CE;
the signaling includes an identifier in a MAC subheader to identify a type of the MAC-CE as a BSR MAC-CE for the uplink physical layer information;
the MAC-CE has higher priority than another MAC-CE for MAC multiplexing;
the programming also includes instructions to, or to cause a processor to, transmit, by the UE to the network device, an indication as to whether a type of physical layer information is present in the physical layer information, and a value of the type of physical layer information if present;
the signaling is further indicative of which of multiple different types of uplink physical layer information are included in the amount of uplink physical layer information;
the signaling is or includes a bitmap to indicate whether each of the multiple different types of uplink physical layer information is included in the amount of uplink physical layer information;
the programming also includes instructions to, or to cause a processor to, transmit, by the UE to the network device, a value of each type of the multiple different types of physical layer information that is included in the amount of uplink physical layer information;
values of types of physical layer information included in the amount of uplink physical layer information are concatenated;
the values are concatenated in order of physical layer information type identifiers that identify the types of physical layer information;
the signaling is transmitted on a communication resource that is configured for uplink physical layer information reporting;
the communication resource is or includes an SR communication resource that is dedicated to uplink physical layer information;
the communication resource is mapped to the amount of uplink physical layer information, a type of uplink physical layer information, or both the amount of uplink physical layer information and a type of uplink physical layer information;
the programming includes instructions to, or to cause a processor to, transmit the uplink physical layer information, by the UE to the network device, on a communication resource that is allocated to the UE based on the amount of uplink physical layer information;
the uplink physical layer information is transmitted in a format that is configured by the network device for the uplink physical layer information.

From the perspective of a network device as an illustrative example, programming stored in or on a non-transitory computer readable storage medium may include instructions to, or to cause a processor to, receive, from a UE in a wireless communication network, signaling indicative of an amount of uplink physical layer information to be transmitted from the UE to the network device. The physical layer information may be or include control information, data information, or both control information and data information in the physical layer.

Embodiments related to network devices or non-transitory computer readable storage media for network device operations may include any one or more of the following features, for example, which are also discussed elsewhere herein:
the uplink physical layer information is determined by the UE;
the uplink physical layer information has no associated logical channel;
the signaling is or includes a BSR indicating the amount of uplink physical layer information;
the BSR is, or is part of, a MAC-CE;
the signaling includes an identifier in a MAC subheader to identify a type of the MAC-CE as a BSR MAC-CE for the uplink physical layer information;
the MAC-CE has higher priority than another MAC-CE for MAC multiplexing;
the programming also includes instructions to, or to cause a processor to, receive, from the UE, an indication as to whether a type of physical layer information is present in the physical layer information, and a value of the type of physical layer information if present;
the signaling is further indicative of which of multiple different types of uplink physical layer information are included in the amount of uplink physical layer information;
the signaling is or includes a bitmap to indicate whether each of the multiple different types of uplink physical layer information is included in the amount of uplink physical layer information;
the programming also includes instructions to, or to cause a processor to, receive, from the UE, a value of each type of the multiple different types of physical layer information that is included in the amount of uplink physical layer information;
values of types of physical layer information included in the amount of uplink physical layer information are concatenated;
the values are concatenated in order of physical layer information type identifiers that identify the multiple types of physical layer information;
the signaling is received on a communication resource that is configured for uplink physical layer information reporting;
the communication resource is or includes an SR communication resource that is dedicated to uplink physical layer information;
the communication resource is mapped to the amount of uplink physical layer information, a type of uplink physical layer information, or both the amount of uplink physical layer information and a type of uplink physical layer information;
the programming includes instructions to, or to cause a processor to, receive the uplink physical layer information from the UE on a communication resource that is allocated to the UE based on the amount of uplink physical layer information;
the uplink physical layer information is received in a format that is configured by the network device for the uplink physical layer information.

Other features, including those disclosed herein in the context of method embodiments, may also or instead be implemented in apparatus or computer program product embodiments.

Although aspects of the present disclosure have been described with reference to specific features and embodiments thereof, various modifications and combinations can be made thereto without departing from the disclosure. The description and drawings are, accordingly, to be regarded simply as an illustration of some embodiments of the disclosure as defined by the appended claims, and are contemplated to cover any and all modifications, variations, combinations or equivalents that fall within the scope of the present disclosure. Therefore, although embodiments and potential advantages have been described in detail, various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
transmitting signaling indicative of an amount of uplink physical layer information to be transmitted from a user equipment (UE) to a network device,
wherein the uplink physical layer information comprises control information, data information, or both the control information and the data information in a physical layer.

2. The method of claim 1, wherein the uplink physical layer information comprises information that is related to artificial intelligence (AI) model performance.

3. The method of claim 1, wherein the signaling comprises a medium access control-control element (MAC-CE) or uplink physical signaling in physical uplink control channel (PUCCH) or physical uplink shared channel (PUSCH).

4. The method of claim 1, wherein the signaling comprises a buffer status report (BSR) indicating the amount of the uplink physical layer information.

5. The method of claim 4, further comprising:
transmitting an indication as to whether a type of the uplink physical layer information is present in the uplink physical layer information, and a value of the type of the uplink physical layer information when the type of the uplink physical layer information is present.

6. The method of claim 1, wherein the signaling is further indicative of which of a plurality of different types of the uplink physical layer information are included in the amount of the uplink physical layer information.

7. The method of claim 1, wherein the transmitting the signaling comprises transmitting the signaling on a communication resource that is configured for uplink physical layer information reporting.

8. The method of claim 1, comprising:
transmitting the uplink physical layer information on a communication resource that is allocated to the UE based on the amount of the uplink physical layer information.

9. An apparatus applied for a user equipment (UE), comprising:
at least one processor; and
at least one computer readable storage medium, coupled to the at least one processor, storing programming for execution by the at least one processor, the programming including instructions to:
transmit signaling indicative of an amount of uplink physical layer information to be transmitted from the UE to a network device,
wherein the uplink physical layer information comprises control information, data information, or both the control information and the data information in a physical layer.

10. The apparatus of claim 9, wherein the uplink physical layer information comprises information that is related to artificial intelligence (AI) model performance.

11. The apparatus of claim 9, wherein the signaling comprises a medium access control-control element (MAC-CE) or uplink physical signaling in physical uplink control channel (PUCCH) or physical uplink shared channel (PUSCH).

12. The apparatus of claim 9, wherein the signaling comprises a buffer status report (BSR) indicating the amount of the uplink physical layer information.

13. The apparatus of claim 12, the programming further including instructions to:
transmit an indication as to whether a type of the uplink physical layer information is present in the uplink physical layer information, and a value of the type of the uplink physical layer information when the type of the uplink physical layer information is present.

14. The apparatus of claim 9, wherein the signaling is further indicative of which of a amount of the uplink physical layer information.

15. The apparatus of claim 9, wherein the signaling is transmitted on a communication resource that is configured for uplink physical layer information reporting.

16. The apparatus of claim 9, the programming further including instructions to:
transmit the uplink physical layer information on a communication resource that is allocated to the UE based on the amount of the uplink physical layer information.

17. A method comprising:
receiving signaling indicative of an amount of uplink physical layer information to be transmitted from a user equipment (UE) to a network device,
wherein the uplink physical layer information comprises control information, data information, or both the control information and the data information in a physical layer.

18. The method of claim 17, wherein the uplink physical layer information comprises information that is related to artificial intelligence (AI) model performance.

19. The method of claim 17, wherein the signaling comprises a medium access control-control element (MAC-CE) or uplink physical signaling in physical uplink control channel (PUCCH) or physical uplink shared channel (PUSCH).

20. The method of claim 17, wherein the signaling comprises a buffer status report (BSR) indicating the amount of the uplink physical layer information.

21. The method of claim 20, further comprising:
receiving an indication as to whether a type of the uplink physical layer information is present in the uplink physical layer information, and a value of the type of the uplink physical layer information when the type of the uplink physical layer information is present.

22. The method of claim 17, wherein the signaling is further indicative of which of a amount of the uplink physical layer information.

23. An apparatus applied for a network device, comprising:
at least one processor; and
at least one computer readable storage medium, coupled to the at least one processor, storing programming for execution by the at least one processor, the programming including instructions to:
receive signaling indicative of an amount of uplink physical layer information to be transmitted from a user equipment (UE) to the network device,
wherein the uplink physical layer information comprises control information, data information, or both the control information and the data information in a physical layer.

24. The apparatus of claim 23, wherein the uplink physical layer information comprises information that is related to artificial intelligence (AI) model performance.

25. The apparatus of claim 23, wherein the signaling comprises a medium access control-control element (MAC-CE) or uplink physical signaling in physical uplink control channel (PUCCH) or physical uplink shared channel (PUSCH).

26. The apparatus of claim 23, wherein the signaling comprises a buffer status report (BSR) indicating the amount of the uplink physical layer information.

27. The apparatus of claim 26, the programming further including instructions to:
receive an indication as to whether a type of the uplink physical layer information is present in the uplink physical layer information, and a value of the type of the uplink physical layer information when the type of the uplink physical layer information is present.

28. The apparatus of claim 23, wherein the signaling is further indicative of which of a amount of the uplink physical layer information.

29. The apparatus of claim 23, wherein the signaling is received on a communication resource that is configured for uplink physical layer information reporting.

30. The apparatus of claim 23, the programming further including instructions to:
receive the uplink physical layer information on a communication resource that is allocated to the UE based on the amount of the uplink physical layer information.
